(19) United States
(12) Patent Application Publication
(10) Pub. No.: US 2015/0002489 A1
(43) Pub. Date: Jan. 1, 2015

(54) VIDEO OUTPUT DEVICE AND VIDEO OUTPUT METHOD

(71) Applicant: Kabushiki Kaisha Toshiba, Tokyo (JP)

(72) Inventor: Kunihiko KAWAHARA, Tokyo (JP)

(73) Assignee: Kabushiki Kaisha Toshiba, Tokyo (JP)

(21) Appl. No.: 14/271,907

(22) Filed: May 7, 2014

Related U.S. Application Data
(63) Continuation of application No. PCT/JP2013/067930, filed on Jun. 28, 2013.

(51) Int. Cl. G09G 5/00

(52) U.S. Cl. CPC G09G 5/00
USPC 345/204

(57) ABSTRACT

According to one embodiment, a video output device includes a first detachable function expansion module, a second detachable function expansion module, and a controller. The first detachable function expansion module is configured to perform input process on video information. The second detachable function expansion module includes a storage module configured to store therein at least one of font information and screen information. The controller is configured to output, to a display, the video information input from the first function expansion module and the at least one of the font information and the screen information input from the second function expansion module.

### CROSS-REFERENCE TO RELATED APPLICATIONS

This application is a continuation of international application No. PCT/JP2013/067930, filed Jun. 28, 2013, which designates the United States, the entire contents of which are incorporated herein by reference.

### FIELD

Embodiments described herein relate generally to a video output device and a video output method.

### BACKGROUND

Conventional video output devices such as television receivers have functions such as volume control and channel selection that are common regardless of regions or users' requests. However, there are several functions such as a digital method, a remote controller, and a recording function that vary according to regions or user's requests.

In view of the above, conventional technologies provide different kinds of video output devices according to regions or users' requests, which has increased a development burden.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram illustrating a television display device according to a first embodiment;

FIG. 2 is an exemplary diagram illustrating the basic structure of the television display device, in the first embodiment;

FIG. 3 is an exemplary flowchart illustrating a procedure of processing at startup in the television display device in the first embodiment;

FIG. 4 is an exemplary flowchart illustrating a procedure of power supply processing from a power supply in the television display device in the first embodiment;

FIG. 5 is an exemplary diagram illustrating a configuration in which the television display device comprises an input module as a function expansion module, in the first embodiment;

FIG. 6 is an exemplary flowchart illustrating a processing procedure until video data input from the input module is displayed in the input module, in the first embodiment;

FIG. 7 is an exemplary flowchart illustrating a processing procedure until input video data is recorded in the input module in the first embodiment;

FIG. 8 is an exemplary flowchart illustrating the procedure of processing until video data recorded in a hard disk drive in the television display device in the first embodiment;

FIG. 9 is an exemplary diagram illustrating a configuration in which the television display device comprises the input module and an output module as function expansion modules, in the first embodiment;

FIG. 10 is an exemplary flowchart illustrating the procedure of processing in which video data and the like input from the input module is output from the output module in the television display device in the first embodiment;

FIG. 11 is an exemplary diagram illustrating a configuration in which the television display device comprises a network communication module as a function expansion module, in the first embodiment;

FIG. 12 is an exemplary flowchart illustrating the procedure of processing until video data and the like input to the network communication module is recorded in the television display device in the first embodiment;

FIG. 13 is an exemplary flowchart illustrating a processing procedure in which a menu screen stored in the network communication module is displayed in the television display device in the first embodiment;

FIG. 14 is an exemplary diagram of a menu screen read from a menu information holding module and a font information holding module of a network communication module for a first region, in the first embodiment;

FIG. 15 is an exemplary diagram of a menu screen read from a menu information holding module and a font information holding module of a network communication module for a second region different from the first region, in the first embodiment;

FIG. 16 is an exemplary flowchart illustrating the procedure of processing in which the network communication module communicates with the outside in the television display device in the first embodiment;

FIG. 17 is an exemplary diagram illustrating a configuration in which the television display device comprises a sensor module as a function expansion module, in the first embodiment;

FIG. 18 is an exemplary flowchart illustrating a procedure of processing information acquired by a sensor in the television display device in the first embodiment;

FIG. 19 is an exemplary diagram illustrating a configuration in which the television display device comprises a plurality of input modules as function expansion modules, in the first embodiment;

FIG. 20 is an exemplary flowchart illustrating a procedure of processing to merge video data input to a first input module and video data input to a second input module in the television display device in the first embodiment;

FIG. 21 is an exemplary diagram illustrating a configuration in which a television display device comprises a plurality of power supply modules as function expansion modules, according to a second embodiment; and

FIG. 22 is an exemplary flowchart illustrating the procedure of power supply processing from a power supply in the television display device in the second embodiment.

### DETAILED DESCRIPTION

In general, according to one embodiment, a video output device comprises a first detachable function expansion module, a second detachable function expansion module, and a controller. The first detachable function expansion module is configured to perform input process on video information. The second detachable function expansion module comprises a storage module configured to store therein at least one of font information and screen information. The controller is configured to output, to a display, the video information input from the first function expansion module and the at least one of the font information and the screen information input from the second function expansion module.

Embodiments below describe examples of a video output device adopted to a television display device. The embodiments described below do not limit the video output device to the television display device, and the video output device may be any device that outputs video data to a display.

### First Embodiment

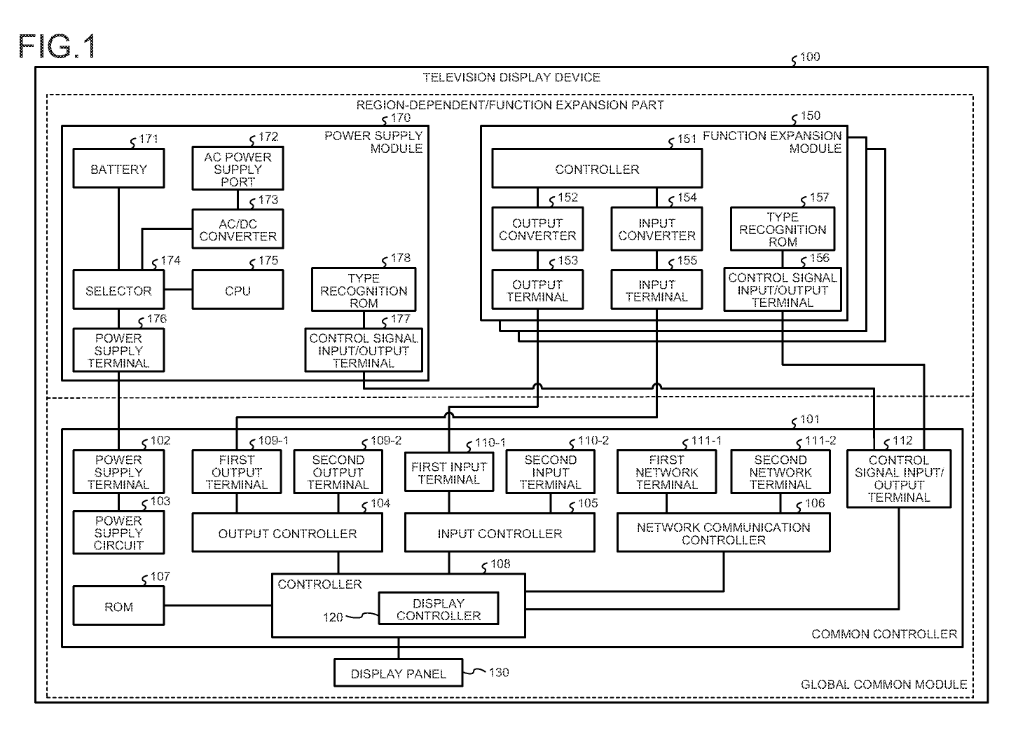

FIG. 1 is a schematic diagram illustrating a television display device 100 according to a first embodiment. In the example illustrated in FIG. 1, the television display device 100 is separated into a region-dependent/function expansion part and a global common module.

The region-dependent/function expansion part is a part to which a component that is attached and detached according to regions or users' requests is connected. The present embodiment refers to, as a function expansion module, a component that is provided in the region-dependent/function expansion part and provides a function to the global common module when being connected.

The global common module is a part in which a component that is common regardless of regions or users' requests is provided. The present embodiment provides an example in which the global common module comprises a common controller 101 and a display panel 130. The common controller 101 controls the function expansion module in order to utilize a function provided by the function expansion module.

Various modules are detachably provided as the function expansion modules to the television display device 100 according to the present embodiment. FIG. 1 is an example in which a function expansion module 150 and a power supply module 170 are provided as detachable function expansion modules.

The function expansion module 150 comprises a controller 151, an output converter 152, an output terminal 153, an input converter 154, an input terminal 155, a control signal input/output terminal 156, and a type recognition read-only memory (ROM) 157. FIG. 1 schematically illustrates the function expansion module 150 having a configuration necessary for a function expansion module according to the present embodiment. Specific function expansion modules will be described below.

The type recognition ROM 157 stores therein data for identifying the type of the function expansion module 150. In other words, the common controller 101 refers to the type recognition ROM 157 to identify the type of the function expansion module 150, that is, the function provided by the function expansion module 150.

The control signal input/output terminal 156 is an interface for performing control, status reading, and the like mutually between components. For example, the common controller 101 controls the function expansion module 150 through the control signal input/output terminal 156. The common controller 101 reads the data stored in the type recognition ROM 157 through the control signal input/output terminal 156 to recognize the type of the function expansion module 150.

The input terminal 155 inputs video data and audio data from the common controller 101. In other words, after the common controller 101 recognizes the function of the function expansion module 150, when the function of the function expansion module 150 is desired to be utilized, the video data and audio data are input to the function expansion module 150 through the input terminal 155.

The input converter 154 converts an electric signal input from the input terminal 155 into a logic signal. The input converter 154 thus performs signal conversion at a physical layer level.

The controller 151 controls the entire function expansion module 150 and processes the input video data and audio data through the function provided by the function expansion module 150. The function provided by the function expansion module 150 is not in particular limited. Described below are examples of the function provided by the function expansion module 150 according to the present embodiment.

The output converter 152 converts the logic signal of the video data and audio data processed by the controller 151 into a transmission signal at the physical layer level in order to transmit the logic signal to the common controller 101. For example, the transmission signal may be HDMI (registered trademark), Displayport, or MHL.

The output terminal 153 outputs to the common controller 101 (through an interface for home appliances) the video data and audio data converted into the transmission signal by the output converter 152. The function expansion module does not necessarily need to have both the input terminal and the output terminal and may have only one of them. Neither the input terminal nor the output terminal may be provided as in the power supply module 170.

The power supply module 170 illustrated in FIG. 1 is an example of the function expansion module attachable and detachable to and from the television display device 100. As illustrated in FIG. 1, the power supply module 170 comprises a battery 171, an AC power supply port 172, an AC/DC converter 173, a selector 174, a CPU 175, a power supply terminal 176, a control signal input/output terminal 177, and a type recognition ROM 178.

The power supply terminal 176 is a terminal for supplying power to the common controller 101.

The selector 174 selects a power supply that supplies power to the power supply terminal 176 from the battery 171 and the AC power supply port 172.

The battery 171 has a function of accumulating power supplied from the AC power supply port 172 and a function of supplying power to the power supply terminal 176.

The AC power supply port 172 is a port to which power is externally supplied. Because externally supplied power varies by region, the AC power supply port 172 also varies by region. Because of this, the power supply module 170 comprising the AC power supply port 172 is also provided by region. In other words, the television display device 100 according to the present embodiment achieves power supply according to regional circumstances by installing the power supply module 170 according to regions.

The AC/DC converter 173 converts the power supplied from the AC power supply port 172 from alternating current (AC) to direct current (DC). Because the specification of the AC/DC converter 173 varies by region as is the case with the AC power supply port 172, the AC/DC converter 173 is also a module adapted to a region.

The control signal input/output terminal 177 is an interface for performing control, status reading, and the like mutually between components. For example, the common controller 101 controls the power supply module 170 through the control signal input/output terminal 177. The common controller 101 reads data stored in the type recognition ROM 178 through the control signal input/output terminal 177 to recognize the type of the function expansion module (e.g., the power supply module 170).

The type recognition ROM 178 stores therein data that identifies the type of the power supply module 170. In other words, the common controller 101 refers to the common controller 101, thereby recognizing that the connected component is a power supply.

The CPU 175 controls the entire power supply module 170.

The television display device 100 according to the present embodiment has the power supply module 170 according to regions or users' requests connected to the television display device 100. For example, the battery 171 may be provided for a region with unstable power supply, or the battery 171 may not be provided for a region to which power is supplied at all times. The electricity accumulation amount of the battery 171 may be varied according to users' requests.

The global common module comprises the common controller 101 and the display panel 130 that are parts provided in common regardless of regions or users' requests.

The display panel 130 is a display having a display screen for displaying information. The display panel 130 may be, for example, a display panel that supports 4K2K (3840×2160), of which the resolution and the like vary according to embodiments.

The common controller 101 comprises a power supply terminal 102, a power supply circuit 103, an output controller 104, an input controller 105, a network communication controller 106, a ROM 107, a controller 108, a first output terminal 109-1, a second output terminal 109-2, a first input terminal 110-1, a second input terminal 110-2, a first network terminal 111-1, a second network terminal 111-2, and a control signal input/output terminal 112.

The power supply terminal 102 is a terminal for power supply input. The power supply terminal 102 is supplied with power from the power supply module 170 (of what is called the region-dependent/function expansion part) that is a component varying according to regions or the like.

The power supply circuit 103 supplies power supplied through the power supply terminal 102 to the modules within the common controller 101 and a component of the region-dependent/function expansion part (e.g., the function expansion module 150).

The first input terminal 110-1 and the second input terminal 110-2 are interfaces that connect with components provided in the region-dependent/function expansion part (e.g., the function expansion module 150) to input a signal. The present embodiment is an example of providing a plurality of input terminals. This allows connection with a plurality of function expansion modules for video input (e.g., the function expansion module 150).

The input controller 105 processes a signal input from the region-dependent/function expansion part (e.g., the function expansion module 150) connected through the first input terminal 110-1 and the second input terminal 110-2. For example, a signal for HDMI (registered trademark), Displayport, or MHL is converted into a signal that is usable within the common controller 101.

The first network terminal 111-1 and the second network terminal 111-2 are interfaces for performing transmission and reception with a component comprised in the region-dependent/function expansion part connected through a network such as Ethernet (registered trademark).

The network communication controller 106 establishes network connection with respective components connected through the first network terminal 111-1 and the second network terminal 111-2 to perform control on data transmission and reception.

The ROM 107 is a ROM that stores therein firmware to be read by the controller 108.

The controller 108 comprises a display controller 120 and controls the entire common controller 101.

The display controller 120 performs image processing on video data and the like. The display controller 120 according to the present embodiment performs image processing on input video data and outputs the video data to the display panel 130.

The first output terminal 109-1 and the second output terminal 109-2 are interfaces that connect with the components provided in the region-dependent/function expansion part (e.g., the function expansion module 150) to output a signal. The present embodiment is an example of providing a plurality of output terminals. This allows connection with a plurality of function expansion modules for video output.

The output controller 104 generates a signal to be output to the region-dependent/function expansion part (e.g., the function expansion module 150) connected through the first output terminal 109-1 and the second output terminal 109-2. For example, the signal is converted into a signal for HDMI (registered trademark), Displayport, or MHL.

The control signal input/output terminal 112 is a terminal that transmits and receives a control signal for controlling the components provided in the region-dependent/function expansion part (e.g., the function expansion module 150). The controller 108 is connected through the control signal input/output terminal 112 to the type recognition ROMs 157, 178 as the components of the region-dependent/function expansion part (e.g., the function expansion module 150 and the power supply module 170).

The controller 108 can read data in the type recognition ROMs 157, 178 as the components of the connected region-dependent/function expansion part (e.g., the function expansion module 150 and the power supply module 170) through the control signal input/output terminal 112.

Thus, the common controller 101 according to the present embodiment displays the video data and audio data input from the components provided in the connected region-dependent/function expansion part (e.g., the function expansion module 150). In other words, the common controller 101 according to the present embodiment performs control independent of regions or users' requests, that is, the control for displaying the input video data and audio data on the display panel 130.

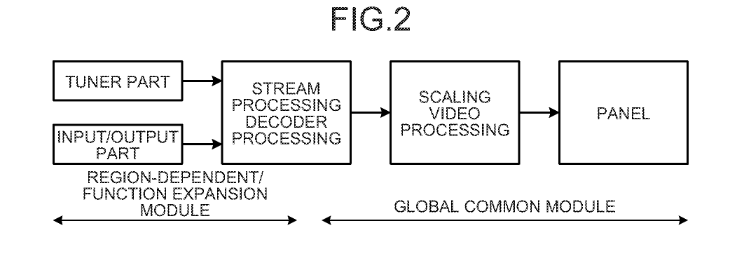

FIG. 2 is a diagram illustrating the basic structure of the television display device 100 according to the present embodiment. As illustrated in FIG. 2, the television display device 100 is configured with a combination of the region-dependent/function expansion part and the global common module. Because these components have not been separated conventionally, whole products have been produced according to regions or users' requests, causing low efficiency and low functional expandability, for example.

The television display device 100 according to the present embodiment isolates the component of the region-dependent/function expansion part and the component of the global common module from each other and makes the component of the region-dependent/function expansion part replaceable, detachable, and controllable by the component of the global common module.

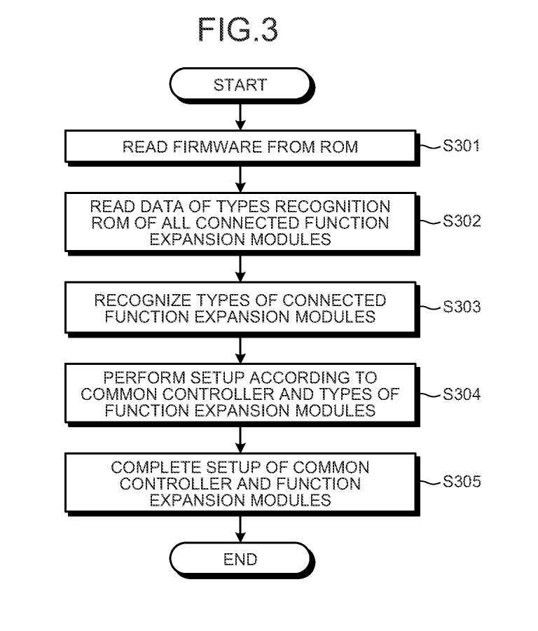

Described next is processing at startup in the television display device 100 according to the present embodiment. FIG. 3 is flowchart illustrating the procedure of the above processing in the television display device 100 according to the present embodiment.

First, the controller 108 reads the firmware from the ROM 107 (S301). The controller 108 then reads the data of the type recognition ROMs of all the function expansion modules (the components comprised in the region-dependent/function expansion part) connected to the common controller 101 through the control signal input/output terminal 112 (S302).

The controller 108 recognizes the types (classifications) of all the function expansion modules (the components comprised in the region-dependent/function expansion part) connected to the common controller 101 (S303).

The controller 108 then performs a setup according to the common controller 101 and the types (classifications) of the connected function expansion modules (S304).

The setup of the common controller 101 and the function expansion modules connected to the common controller 101 is then completed (S305).

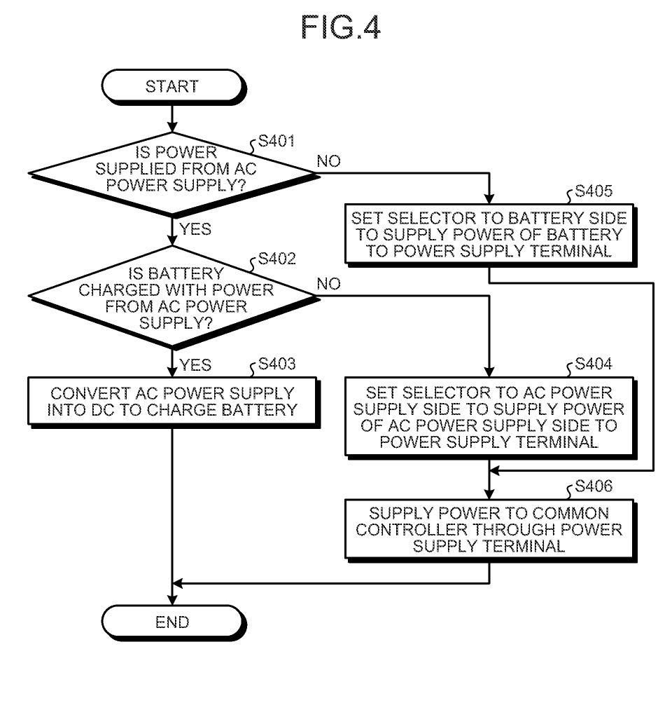

Described next is power supply processing from a power supply in the television display device 100 according to the present embodiment. FIG. 4 is a flowchart illustrating the procedure of the above processing procedure in the television display device 100 according to the first embodiment.

First, the CPU 175 of the power supply module 170 determines whether power is to be supplied from an AC power supply connected through the AC power supply port 172 (S401). If the CPU 175 determines that power is not to be supplied from the AC power supply (No at S401), it sets the selector 174 to the battery 171 side to supply the power of the battery 171 to the power supply terminal 176 (S405).

If the CPU 175 of the power supply module 170 determines that power is to be supplied from the AC power supply (Yes at S401), the CPU 175 further determines whether the battery 171 is to be charged with the power from the AC power supply (S402). If the CPU 175 determines that the battery 171 is to be charged with the power (Yes at S402), it causes the power supplied from the AC power supply to be converted into DC through the AC/DC converter 173 to charge the battery 171 (S403).

If the CPU 175 determines that the battery 171 is not to be charged (No at S402), it sets the selector 174 to the AC power supply side to supply the power of the AC power supply side to the power supply terminal 176 (S404). After the processing at S404 and 5405, the power is supplied to the common controller 101 through the power supply terminal 102 (S406).

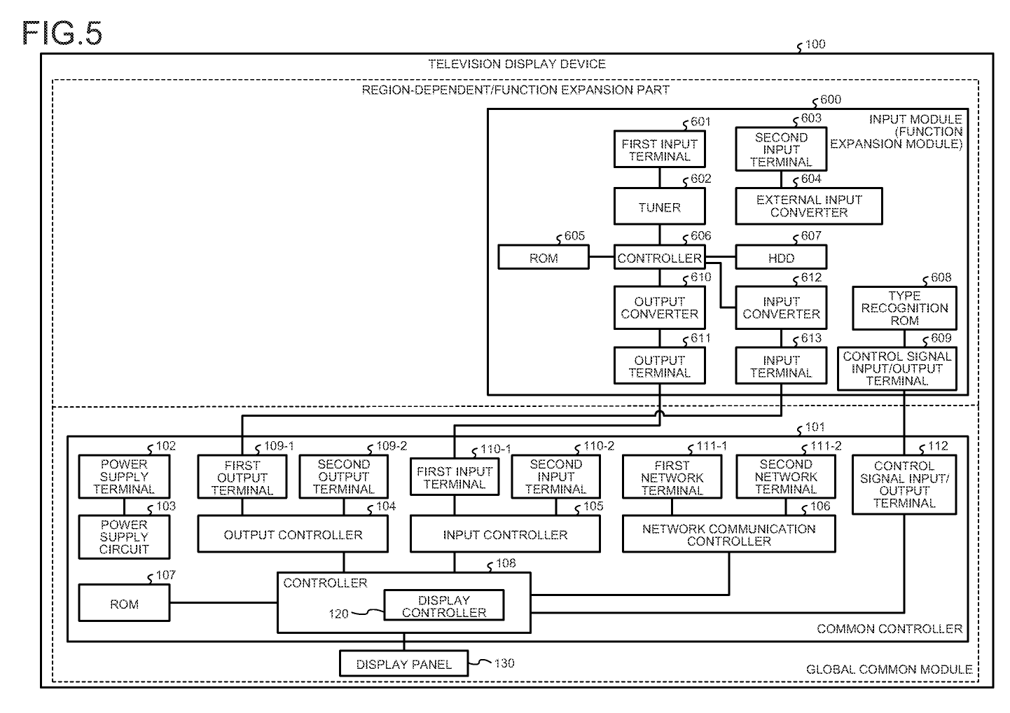

FIG. 5 is a diagram illustrating a configuration in which the television display device 100 according to the first embodiment comprises an input module 600 as the function expansion module. As illustrated in FIG. 5, the input module 600 comprises a first input terminal 601, a tuner 602, a second input terminal 603, an external input converter 604, a ROM 605, a controller 606, a hard disk drive (HDD) 607, a type recognition ROM 608, a control signal input/output terminal 609, an output converter 610, an output terminal 611, an input converter 612, and an input terminal 613. Other function expansion modules comprising the power supply module 170 are omitted from FIG. 5.

The output terminal 611, the output converter 610, the input converter 612, the input terminal 613, and control signal input/output terminal 609 perform similar processing to the output converter 152, the output terminal 153, the input converter 154, the input terminal 155, and the control signal input/output terminal 156 in FIG. 1, respectively, and the description thereof will be omitted.

The first input terminal 601 is a terminal that receives a broadcast wave. Because this specification varies by region, it is a module adapted to a region.

The tuner 602 receives the signal of the broadcast wave input through the first input terminal 601 and coverts the signal into a logic signal. Because the tuner 602 varies by region, it is a module adapted to a region.

The second input terminal 603 is a terminal that inputs external video data and audio data as a transmission signal at the physical layer level of an interface for home appliances. The transmission signal to be input is, for example, a signal for HDMI (registered trademark), Displayport, or MHL. Because the specification of the input terminal varies by region or target user of the product, the second input terminal 603 is a module adapted to a region or a target user of the product.

The external input converter 604 converts an electric signal input from the second input terminal 603 into a logic signal. Thus, the external input converter 604 performs signal conversion at the physical layer level.

The controller 606 receives video data and audio data from the tuner 602 and the external input converter 604 and performs decode processing, video processing, and audio processing thereon. The controller 606 outputs the processed video data and audio data to the output converter 610. The controller 606 is communicable with the common controller 101 through the control signal input/output terminal 609.

The controller 606 performs processing such as blend on the video data and audio data input from at least one or both of the first input terminal 601 and the second input terminal 603.

The type recognition ROM 608 stores therein data for identifying the type of the input module 600.

The common controller 101 reads the data stored in the type recognition ROM 608 through the control signal input/output terminal 609, thereby recognizing the input module 600 (as the type of the function expansion module).

The ROM 605 is a ROM that stores therein firmware to be read by the controller 606.

The HDD 607 records the video data and audio data input from at least one of the first input terminal 601 and the second input terminal 603 and processed by the controller 606. The input module 600 according to the present embodiment can continue to record video data and audio data even when the power of the common controller 101 is turned off.

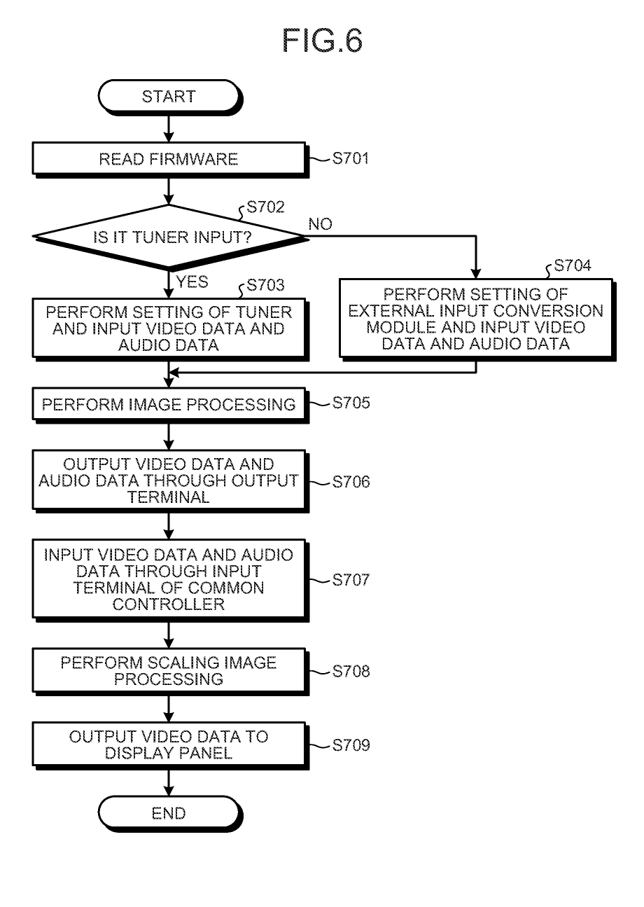

Described next is processing until video data input from the input module 600 is displayed in the television display device 100 according to the present embodiment. FIG. 6 is a flowchart illustrating the procedure of the above processing in the input module 600 according to the present embodiment. Note that the setup at startup illustrated in FIG. 3 is completed.

First, the controller 606 reads the firmware stored in the ROM 605 (S701). The controller 606 then determines whether, when video data and audio data are input, the inputting is through the tuner 602 (S702).

If the controller 606 determines that the inputting is through the tuner 602 (Yes at S702), it performs the setting of the tuner 602 and receives the inputting of the video data and audio data from the tuner 602 (S703).

If the controller 606 determines that the inputting is not through the tuner 602 (No at S702), it performs the setting of the external input converter 604 and receives the inputting of the video data and audio data from the external input converter 604 (S704).

The controller 606 performs image processing on the input video data (S705). Along with this, processing is also performed on the audio data as needed.

Next, the input module 600 converts the video data and audio data processed by the controller 606 through the output converter 610 and then outputs the video data and audio data through the output terminal 611 (S706).

The common controller 101 receives the inputting of the video data and audio data through the first input terminal 110-1 (S707). The input controller 105 performs conversion and the like on the input video data and audio data, and then the display controller 120 performs scaling image processing on the input video data (S708). The image processing performed is not limited to the scaling image processing and may be any image processing for display on the display panel 130 so long as it is independent of regions or users' requests.

The display controller 120 outputs the video data to the display panel 130 (S709). Through the above processing, the video data input to the input module 600 is displayed.

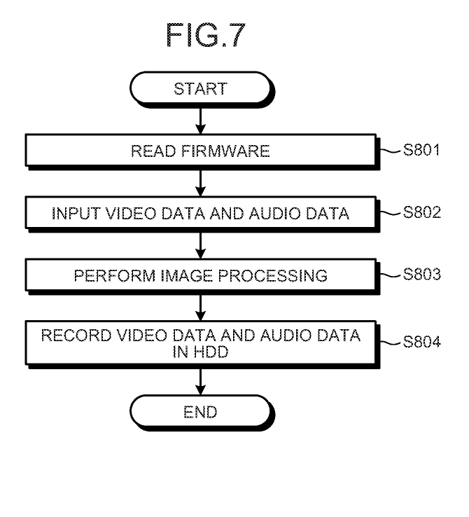

The input module 600 not only can output the input video data and the like to the common controller 101, but also can record the video data in the HDD 607. Described next is processing until the input module 600 records the input video data. FIG. 7 is a flowchart illustrating the procedure of the processing in the input module 600 according to the first embodiment. Note that the setup at startup illustrated in FIG. 3 is completed.

First, the controller 606 reads the firmware stored in the ROM 605 (S801). The controller 606 then receives the inputting of video data and audio data (S802). The inputting of the video data and audio data may be through the tuner 602 or the external input converter 604.

The controller 606 performs image processing on the input video data (S803). Along with this, processing is also performed on the audio data as needed.

The controller 606 then records the video data subjected to the image processing and the audio data in the HDD 607 (S804).

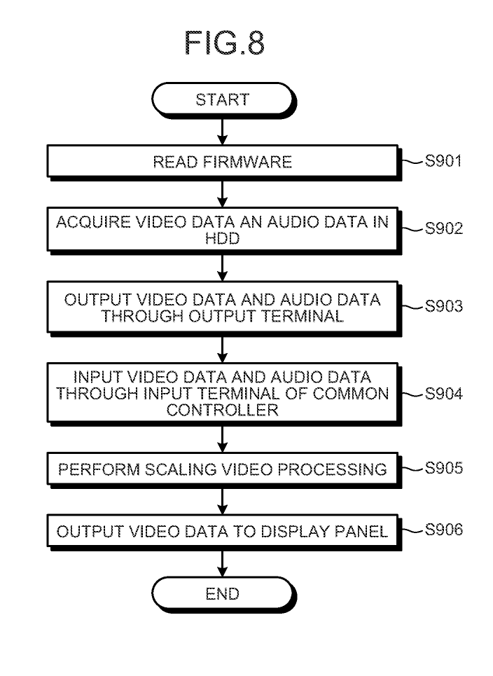

Through the above processing procedure, the video data and the like are stored in the HDD 607. Described next is processing until the video data stored in the HDD 607 is displayed. FIG. 8 is a flowchart illustrating the procedure of the above processing in the television display device 100 according to the present embodiment. Note that the setup at startup illustrated in FIG. 3 is completed.

First, the controller 606 reads the firmware stored in the ROM 605 (S901). The controller 606 then acquires the video data and audio data recorded in the HDD 607 (S902).

Next, the input module 600 converts the video data and audio data processed by the controller 606 through the output converter 610, and then outputs the video data and audio data through the output terminal 611 (S903).

The common controller 101 receives the inputting of the video data and audio data through the first input terminal 110-1 (S904). The input controller 105 performs conversion and the like on the input video data and audio data, and the display controller 120 performs scaling image processing on the input video data (S905).

The display controller 120 outputs the video data to the display panel 130 (S906). Through the above processing, the video data recorded in the HDD 607 is displayed.

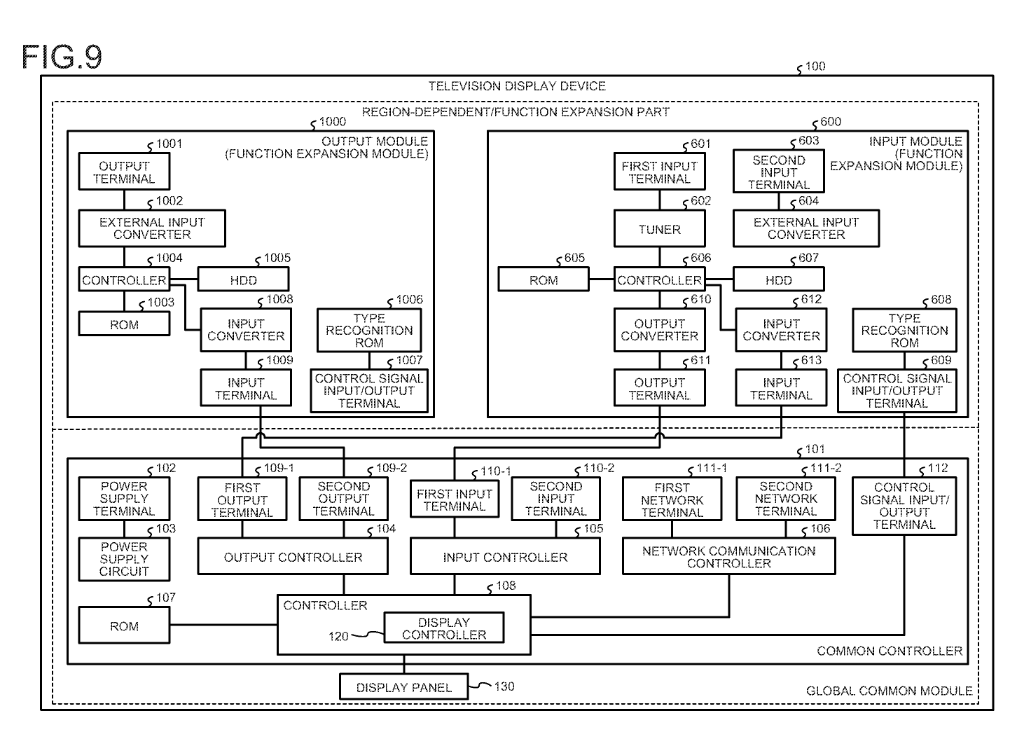

FIG. 9 is a diagram illustrating a configuration in which the television display device 100 according to the first embodiment comprises the input module 600 and an output module 1000 as the function expansion modules. As illustrated in FIG. 9, the output module 1000 comprises an output terminal 1001, an external output converter 1002, a ROM 1003, a controller 1004, an HDD 1005, a type recognition ROM 1006, a control signal input/output terminal 1007, an input converter 1008, and an input terminal 1009. The input module 600 has a similar configuration as that illustrated in FIG. 5, and the description thereof will be omitted. Other function expansion modules comprising the power supply module 170 are omitted from FIG. 9.

The input converter 1008, the input terminal 1009, and the control signal input/output terminal 1007 of the output module 1000 perform similar processing to the input converter 154, the input terminal 155, and the control signal input/output terminal 156 in FIG. 1, respectively, and the description thereof will be omitted.

The ROM 1003 is a ROM that stores therein firmware to be read by the controller 1004.

The controller 1004 performs decode processing, video processing, and audio processing on the video data and audio data input from the common controller 101 through the input terminal 1009 and subjected to conversion and the like performed by the input converter 1008.

The HDD 1005 records therein the video data and audio data processed by the controller 1004 as needed.

The type recognition ROM 1006 stores therein data for identifying the type of the output module 1000.

The external output converter 1002 coverts the video data and audio data input from the controller 1004 into a transmission signal transmittable to the outside at the physical layer level. The transmission signal is, for example, a signal for HDMI (registered trademark), Displayport, or MHL.

The output terminal 1001 outputs the video data and audio data converted into the transmission signal by the external output converter 1002. Because the specification of the output terminal 1001 varies by region or target user of the product, it is a module adapted to a target user or a region. An output destination from the output terminal 1001 is not in particular limited and may be, for example, a large screen display.

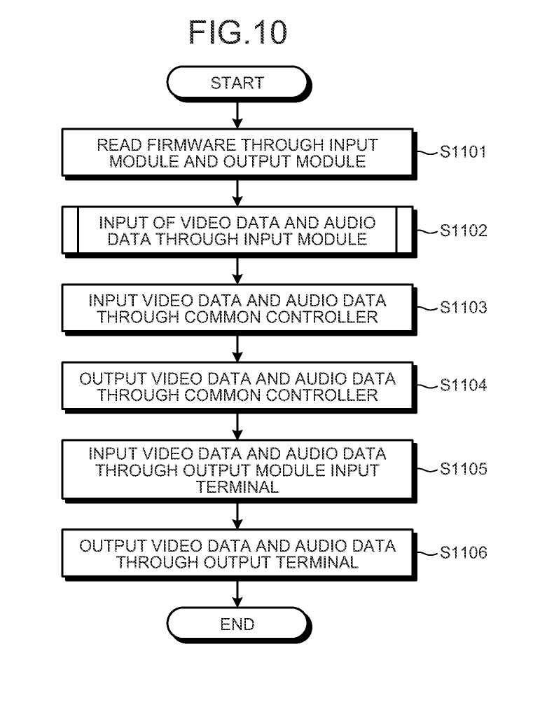

Described next is processing to output the video data and the like input from the input module 600 from the output module 1000. FIG. 10 is a flowchart illustrating the procedure of the above processing in the television display device 100 according to the present embodiment. Note that the setup at startup illustrated in FIG. 3 is completed.

First, the controller 606 of the input module 600 reads the firmware stored in the ROM 605, and the controller 1004 of the output module 1000 reads the firmware stored in the ROM 1003 (S1101).

Performed next is the input processing of video data and audio data by the input module 600 (S1102). This input processing is similar processing from S702 to S706 in FIG. 6, and the description thereof will be omitted.

The common controller 101 receives the inputting of the video data and audio data through the first input terminal 110-1 (S1103). The common controller 101 performs conversion and the like on the input video data and audio data through the input controller 105, performs further conversion and the like thereon through the output controller 104, and outputs the video data and audio data through the second output terminal 109-2 (S1104).

The output module 1000 receives the inputting of the video data and audio data through the input terminal 1009 (S1105).

The output module 1000 performs conversion and the like on the input video data and audio data through the input converter 1008, performs processing on the video data and audio data through the controller 1004, performs further conversion and the like thereon through the external output converter 1002, and outputs the video data and audio data through the output terminal 1001 (S1106).

Through the above processing procedure, the video data and the like input by the input module 600 can be output from the output module 1000.

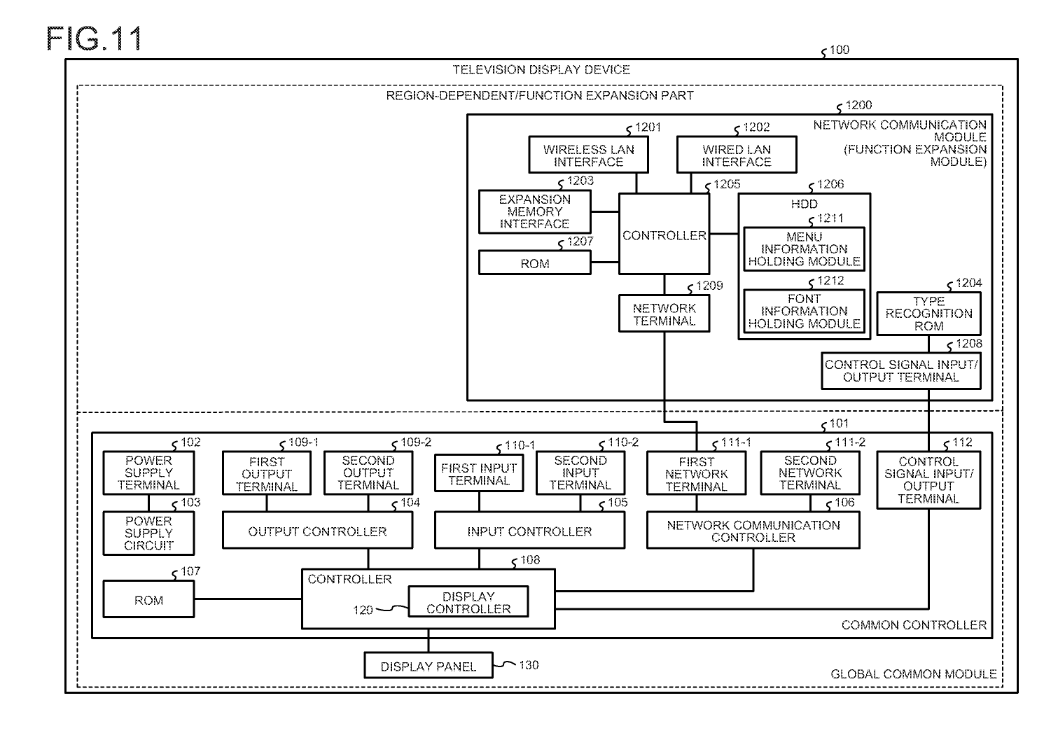

FIG. 11 is a diagram illustrating a configuration in which the television display device 100 according to the present embodiment comprises a network communication module 1200 as the function expansion module. As illustrated in FIG. 11, the network communication module 1200 comprises a wireless LAN interface 1201, a wired LAN interface 1202, an expansion memory interface 1203, a type recognition ROM 1204, a controller 1205, an HDD 1206, a ROM 1207, a control signal input/output terminal 1208, and a network terminal 1209. Other function expansion modules comprising the power supply module 170, the input module 600, and the output module 1000 are omitted in FIG. 11.

The control signal input/output terminal 1208 performs similar processing to the control signal input/output terminal 156 in FIG. 1, and the description thereof will be omitted.

The wireless LAN interface 1201 is an interface capable of communicating with the outside through a wireless LAN.

The wired LAN interface 1202 is an interface capable of communicating with the outside through a wired LAN.

The type recognition ROM 1204 stores therein data for identifying the type of the network communication module 1200.

The ROM 1207 is a ROM that stores therein firmware to be read by the controller 1205.

The controller 1205 controls the components comprised in the network communication module 1200.

The network terminal 1209 inputs and outputs data to and from the common controller 101 through a network or a bus (e.g., Ethernet (registered trademark), PCI Express, or USB).

The HDD 1206 records therein various data (e.g., video data and audio data).

The television display device 100 according to the present embodiment stores information relating to regions or users' requests in the function expansion module in the region-dependent/function expansion part. In other words, the television display device 100 stores font information for displaying character strings and the like on a screen in addition to screen information such as a menu screen and a help screen displayed according to users' requests in the function expansion module.

In the present embodiment, the HDD 1206 of the network communication module 1200 comprises a menu information holding module 1211 and a font information holding module 1212.

The menu information holding module 1211 holds therein menu information for displaying a screen according to service and the like provided for each region.

The font information holding module 1212 holds therein font information according to languages used in each region.

In other words, the present embodiment installs the network communication module 1200 according to a region, thereby displaying a menu screen and a help screen corresponding to the region in the font of a language according to the region.

The common controller 101 sends a menu screen output instruction to the network communication module 1200. The network communication module 1200 reads menu screen information from the menu information holding module 1211 according to the output instruction and outputs the information to the common controller 101. The common controller 101 displays the input menu screen and help screen on the display panel 130. The menu screen output instruction and the like are common regardless of regions or users' requests. This causes the common controller 101 to display a menu screen and the like corresponding to a region without any consideration of regions and the like.

The present embodiment describes an example of providing the menu information holding module 1211 and the font information holding module 1212 in the HDD 1206 of the network communication module 1200. However, without being limited to being provided in the network communication module 1200, they may be in the components (the function expansion modules) provided in the region-dependent/function expansion part such as the input module 600, the output module 1000, and the power supply module 170.

The expansion memory interface 1203 is an interface connected with an expansion memory (not illustrated; e.g., a flash memory). The expansion memory interface 1203 according to the present embodiment can store therein video data as is the case with the HDD 1206 and can record log data that records the conditions and the like of the television display device 100 and the like.

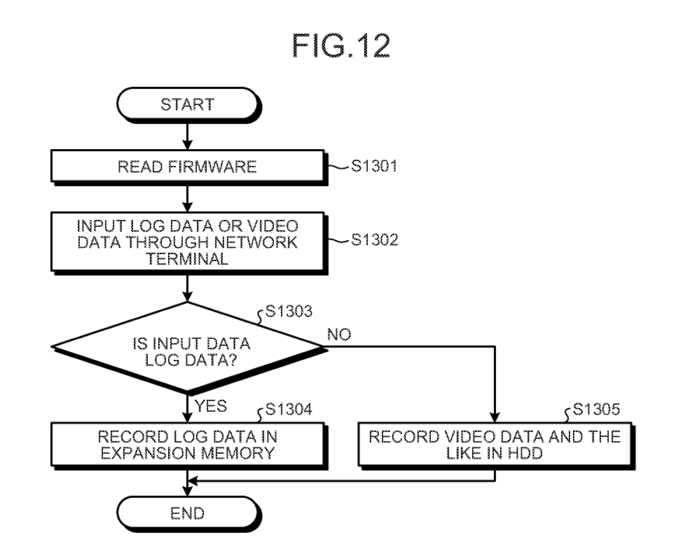

Described next is a procedure until the video data and the like input to the network communication module 1200 are recorded. FIG. 12 is a flowchart illustrating the procedure of the above processing in the television display device 100 according to the present embodiment. Note that the setup at startup illustrated in FIG. 3 is completed.

First, the controller 1205 of the network communication module 1200 reads the firmware stored in the ROM 1207 (S1301).

Next, the network communication module 1200 performs processing to input log data or video data through the network terminal 1209 (S1302).

The controller 1205 of the network communication module 1200 determines whether the input data is log data indicating the conditions and the like of the television display device 100 (S1303). If the controller 1205 determines that the input data is log data (Yes at S1303), the controller 1205 records the log data in the expansion memory through the expansion memory interface 1203 (S1304).

If the controller 1205 determines that the input data is not log data, (No at S1303), the controller 1205 records the input video data and the like in the HDD 1206 (S1305).

The above processing procedure describes a case of recording the log data in the expansion memory and recording the video data and the like in the HDD 1206. However, without being limited to such a separating way, for example, the video data and the like may be recorded in the expansion memory. A recording destination is thus routed in advance according to the type of data, thereby facilitating the management of the data. For example, the log data stored in the recording destination is displayed on the display panel 130 or transmitted to the outside through a wireless or wired network, thereby causing the conditions of the television display device 100 to be recognized.

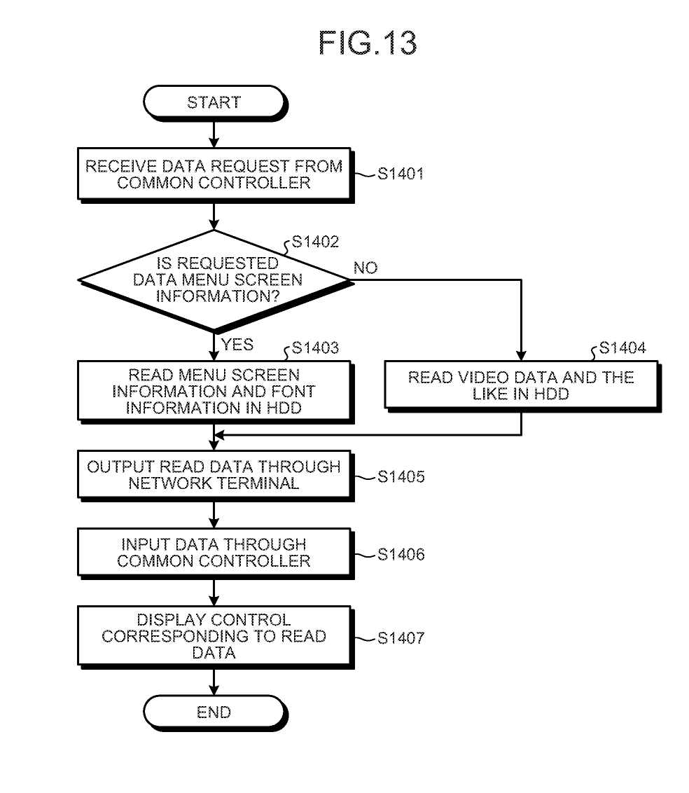

Described next is processing until the menu screen stored in the network communication module 1200 is displayed. FIG. 13 is a flowchart illustrating the procedure of the above processing in the television display device 100 according to the present embodiment. Note that the setup at startup illustrated in FIG. 3 is completed.

The controller 1205 receives a request of (outputting) data from the common controller 101 through the network terminal 1209 (S1401). The controller 1205 then determines whether the requested data is the menu screen information and the like (S1402). If the controller 1205 determines that it is not the menu screen information or the like (No at S1402), it reads the video data and the like from the HDD 1206 (S1404).

If the controller 1205 determines that the requested data is the menu screen information and the like (Yes at S1402), it reads the menu screen information from the menu information holding module 1211 and the font information required for displaying on the menu screen from the font information holding module 1212 in the HDD 1206 (S1403).

The controller 1205 outputs the read data (the video data or the menu screen information and the like) through the network terminal 1209 (S1405).

Next, the common controller 101 receives the inputting of the requested data (the video data or the menu screen information and the like) from the network communication module 1200 through the first network terminal 111-1 (S1406).

The network communication controller 106 performs conversion and the like on the input data, and then the display controller 120 performs display control corresponding to the input data (the video data or the menu screen information and the like) (S1407).

Through the above processing procedure, the video data and the menu screen stored in the network communication module 1200 are displayed on the display panel 130. When the menu screen is displayed, pieces of menu screen information adapted to respective regions stored in the network communication module 1200 are read, thereby displaying menu screens adapted to respective regions.

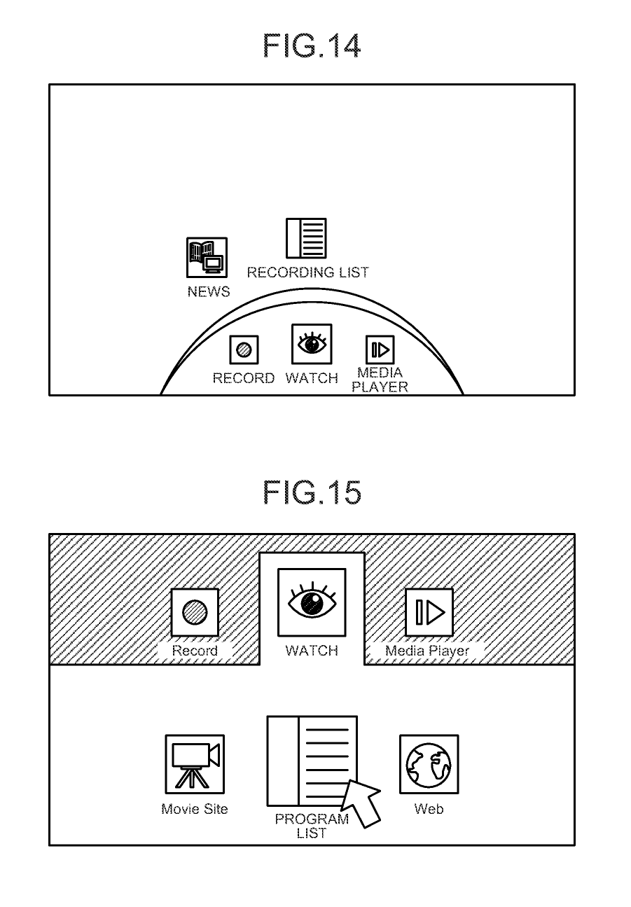

FIG. 14 is an exemplary diagram of a menu screen read from a menu information holding module and a font information holding module of a network communication module for a first region. FIG. 15 is an exemplary diagram of a menu screen read from a menu information holding module and a font information holding module of a network communication module for a second region different from the first region.

Simply using different network communication modules connected to the television display device 100 results in different manners of the menu screen and different font information and the like used in the menu screen. Because the common controller 101 only has to display the menu screen and the like read from the connected network communication module, it can be used as a common component regardless of region.

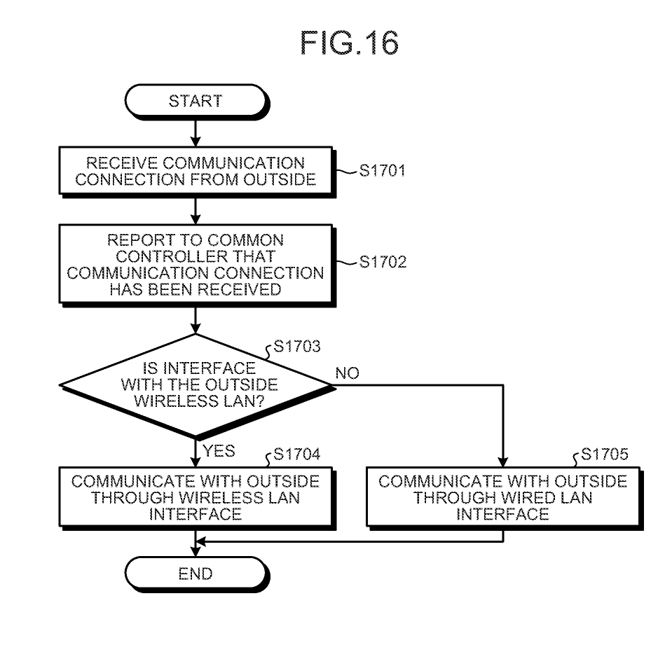

Described next is processing in which the network communication module 1200 communicates with the outside. FIG. 16 is a flowchart illustrating the procedure of processing in which the network communication module communicates with the outside in the television display device 100 according to the present embodiment. Note that the setup at startup illustrated in FIG. 3 is completed.

The controller 1205 receives a connection request from the outside through the wireless LAN interface 1201 or the wired LAN interface 1202 (S1701).

The controller 1205 reports to the common controller 101 through the network terminal 1209 that the communication connection request has been received (S1702). Upon receiving a response with permission for connection from the common controller 101, the controller 1205 determines whether communication is performed with the outside through a wireless LAN (S1703). If the controller 1205 determines that communication is performed through the wireless LAN (Yes at S1703), it performs communication with the outside through the wireless LAN interface 1201 (S1704).

If the controller 1205 determines that communication is not performed through a wireless LAN (No at 51703), it performs communication with the outside through the wired LAN interface 1202 (S1705).

Through the above processing procedure, the television display device 100 according to the present embodiment allows communication with the outside.

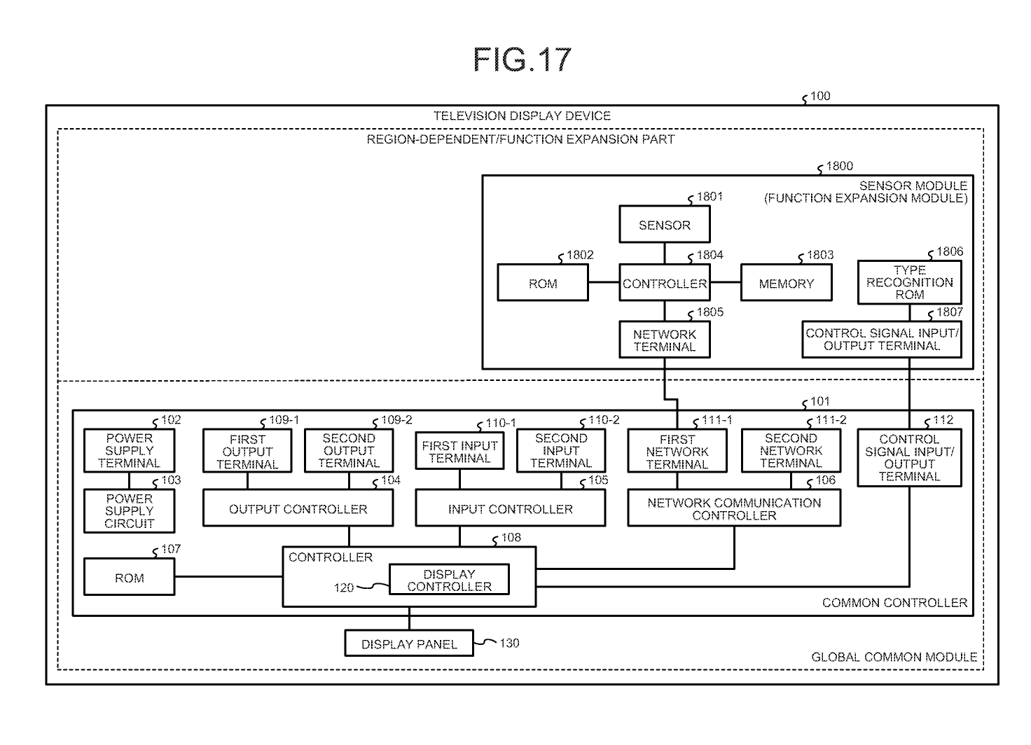

FIG. 17 is a diagram illustrating a configuration in which the television display device 100 according to the present embodiment comprises a sensor module 1800 as the function expansion module. As illustrated in FIG. 17, the sensor module 1800 comprises a sensor 1801, a ROM 1802, a memory 1803, a controller 1804, a network terminal 1805, a type recognition ROM 1806, and a control signal input/output terminal 1807. Other function expansion modules comprising the power supply module 170, the input module 600, the output module 1000, and the network communication module 1200 are omitted in FIG. 17.

The control signal input/output terminal 1807 performs similar processing to the control signal input/output terminal 156 in FIG. 1, and the description thereof will be omitted.

The sensor 1801 acquires information on the external environment of the television display device 100. Examples of the sensor 1801 include an infrared receiver for a remote controller, an imaging module, a gesture detector, and a GPS. The sensor 1801 outputs the detected information to the controller 1804.

Because the specification of the remote controller varies by region or target user of the product, the sensor module 1800 comprising the sensor 1801 is a module corresponding to a region or a target user of the product.

The ROM 1802 is a ROM that stores therein firmware to be read by the controller 1804.

The memory 1803 stores therein the information acquired by the sensor 1801. The controller 1804 controls the components comprised in the sensor module 1800.

The network terminal 1805 inputs and outputs data to and from the common controller 101 through a network or a bus (e.g., Ethernet (registered trademark), PCI Express, or USB).

The type recognition ROM 1806 stores therein data for identifying the type of the sensor module 1800.

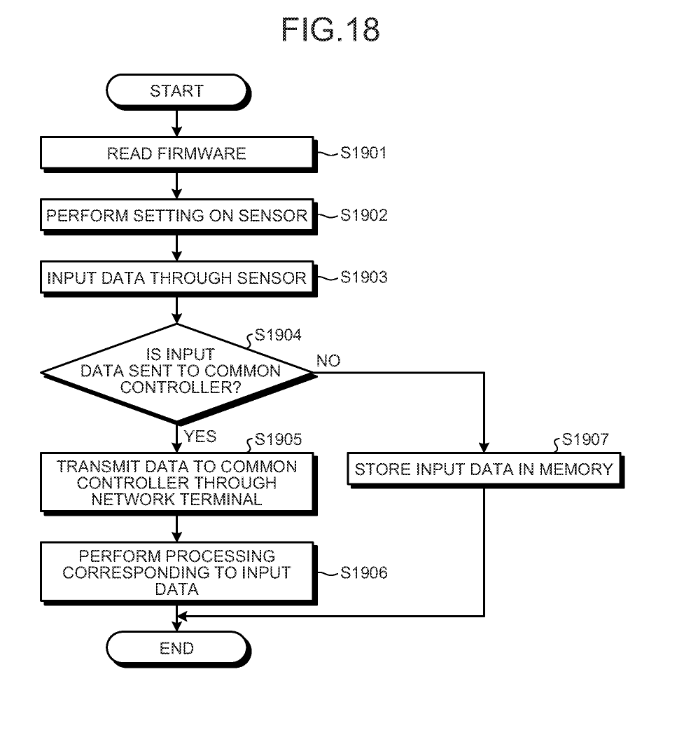

Described next is the processing of the information acquired by the sensor 1801. FIG. 18 is a flowchart illustrating the procedure of the above processing in the television display device 100 according to the present embodiment. Note that the setup at startup illustrated in FIG. 3 is completed.

First, the controller 1804 reads the firmware stored in the ROM 1802 (S1901). The controller 1804 then performs setting on the sensor 1801 (S1902)

Next, the sensor 1801 performs processing to input data on the external environment (e.g., an infrared signal output from a remote controller and image data taken through a lens) (S1903).

The controller 1804 determines whether it sends the input data to the common controller 101 (S1904). If the controller 1804 determines that it does not send the data to the common controller 101 (No at S1904), the controller 1804 stores the data input from the sensor 1801 in the memory 1803 (S1907).

If the controller 1804 determines that it sends the data input from the sensor 1801 to the common controller 101 (Yes at S1904), the controller 1804 transmits the data to the common controller 101 through the network terminal 1805 (S1905).

The common controller 101 performs conversion and the like on the data input through the first network terminal 111-1 through the network communication controller 106, and then the controller 108 performs processing corresponding to the input data (S1906). When the information acquired by the sensor 1801 is an infrared signal from a remote controller, examples of the processing corresponding to the infrared signal include channel switching, volume changes, and turning the power on/off. This flowchart is an example of the processing, and other pieces of processing may be adopted as processing corresponding to the information input by the sensor 1801.

Through the above processing procedure, the television display device 100 according to the present embodiment achieves control according to the information acquired by the sensor 1801.

The present embodiment does not limit the number of modules provided for the respective types of component. For example, the number of input modules is not limited to one, and a plurality of input modules and the like may be provided according to users' requests and the like.

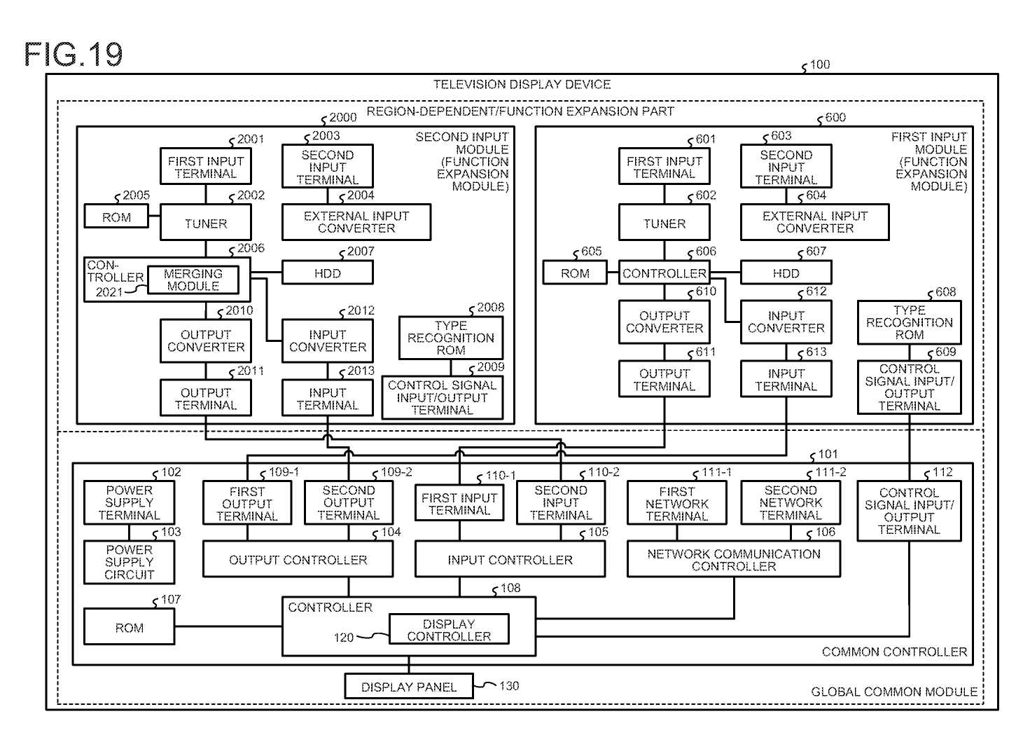

FIG. 19 is a diagram illustrating a configuration in which the television display device 100 according to the present embodiment comprises a plurality of input modules as the function expansion modules. As illustrated in FIG. 19, the television display device 100 comprises the first input module 600 (the input module 600 in FIG. 5) and a second input module 2000. The configuration of the first input module 600 (the input module 600 in FIG. 5) is already described above, and the description thereof will be omitted.

The second input module 2000 comprises a first input terminal 2001, a tuner 2002, a second input terminal 2003, an external input converter 2004, a ROM 2005, a controller 2006, an HDD 2007, a type recognition ROM 2008, a control signal input/output terminal 2009, an output converter 2010, an output terminal 2011, an input converter 2012, and an input terminal 2013.

The first input terminal 2001, the tuner 2002, the second input terminal 2003, the external input converter 2004, the ROM 2005, the controller 2006, the HDD 2007, the type recognition ROM 2008, the control signal input/output terminal 2009, the output converter 2010, the output terminal 2011, the input converter 2012, and the input terminal 2013 of the second input module 2000 are similar to the first input terminal 601, the tuner 602, the second input terminal 603, the external input converter 604, the ROM 605, the controller 606, the HDD 607, the type recognition ROM 608, the control signal input/output terminal 609, the output converter 610, the output terminal 611, the input converter 612, and the input terminal 613 of the first input module 600, respectively, and the description thereof will be omitted.

Note that the firmware stored in the ROM 2005 may be different from the ROM 605. The controller 2006 executes the firmware stored in the ROM 2005 to embody a merging module 2021.

The merging module 2021 performs the merge of a plurality of pieces of video data. The manner of the merge may vary according to regions or users' requests. For example, the merge may be performed so that multi-screen simultaneous display is performed.

The merging module 2021 merges pieces of video data input through the tuner 2002 of the second input module 2000 and the external input converter 2004. The merging module 2021 does not limit video data to be merged, and the merge may be performed on video data input from at least one or both of the tuner 602 and the external input converter 604 of the first input module 600.

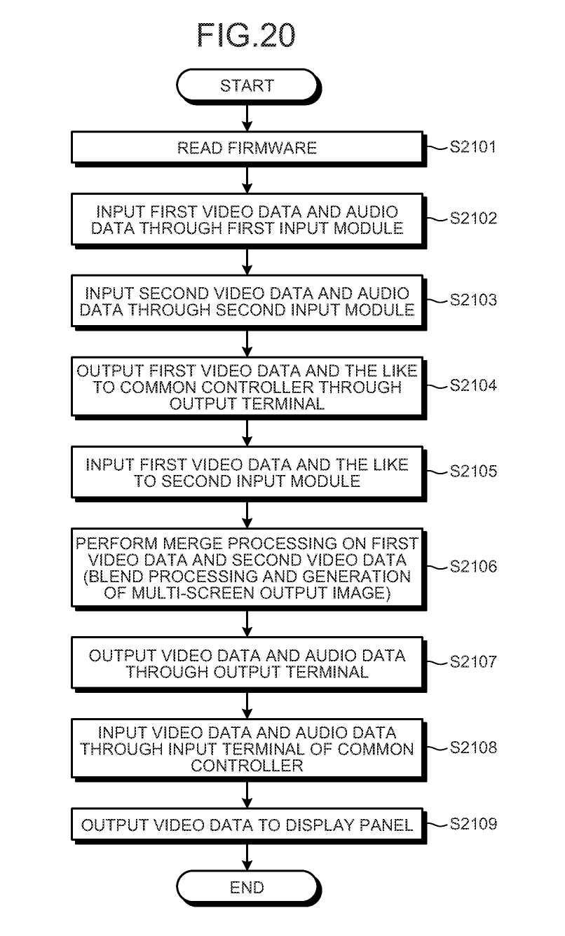

Described next is processing to merge image data input to the first input module 600 and video data input to the second input module 2000. FIG. 20 is a flowchart illustrating the procedure of the above processing in the television display device 100 according to the present embodiment. Note that the setup at startup illustrated in FIG. 3 is completed.

First, the controller 606 of the first input module 600 reads the firmware stored in the ROM 605, and the controller 2006 of the second input module 2000 reads the firmware stored in the ROM 2005 (S2101). Next, the controller 606 of the first input module 600 receives first video data and first audio data through the tuner 602 or the external input converter 604 (S2102).

The controller 2006 of the second input module 2000 receives second video data and second audio data through the tuner 2002 or the external input converter 2004 (S2103).

Next, the controller 606 of the first input module 600 outputs the first video data and the first audio data to the common controller 101 through the output terminal 611 (S2104). At their outputting, signal conversion and the like are performed, whose description is omitted.

The controller 108 of the common controller 101 outputs the first video data and the first audio data input through the first input terminal 110-1 to the second input module 2000 through the second output terminal 109-2 (S2105). The first video data and the first audio data are subjected to signal conversion and the like when they pass through the input controller 105 and the output controller 104, whose description is omitted.

Next, the merging module 2021 of the second input module 2000 performs merge processing on the first video data and the second video data (S2106). Examples of the merge processing include blend processing and the generation of a multi-screen simultaneous display image.

The controller 2006 of the second input module 2000 outputs the video data and audio data subjected to the merge processing through the output terminal 2011 (S2107).

The common controller 101 inputs the video data and audio data subjected to the merge processing through the second input terminal 110-2 (S2108). The video data and audio data subjected to the merge processing are subjected to signal conversion and the like when they pass through the input controller 105, whose description is omitted.

The display controller 120 performs scaling video processing on the video data subjected to the merge processing and then outputs the video data to the display panel 130 (S2109). Through the above processing, the video data subjected to the merge processing is displayed.

The specification of AC power supplies conventionally varies by the destination of products. Conventional television display device products need to be manufactured for respective destinations. In contrast, in the present embodiment, products can be provided according to destinations by making the power supply module detachable and connecting power supply modules according to destinations.

The types and numbers of an input terminal and an output terminal and the capacity of an HDD needed for a television display device have been conventionally different according to target users. Because of this, the types and numbers of the input terminal and the output terminal and the capacity of the HDD have been needed to be set according to target users. In contrast, the present embodiment allows a change in the numbers of the input terminal and the output terminal and the capacity of the HDD by connecting function expansion modules (e.g., the input module and the output module) according to target users. This eliminates the need for having different types and numbers of the input terminal and the output terminal according to respective target users, resulting in a reduction in a development burden.

In other words, the television display device 100 according to the present embodiment can connect a plurality of output modules. When the output modules are connected, the common controller 101 can control so that the output modules output video data. In other words, the present embodiment achieves multiple outputs by connecting the output modules.

The HDD provided in the function expansion module (e.g., the network communication module 1200) of the television display device 100 according to the present embodiment accumulates not only the video data and audio data (that is, recorded data) from the common controller 101 but also log data and dump data of a resister that are generated when an abnormality occurs in the global common module. The accumulated log data may be displayed through the common controller 101 or may be transmitted through an interface (e.g., the wireless LAN interface 1201) connected to an external device. This causes the conditions of the television display device 100 to be recognized.

The specification of the remote controller for use in the television display device 100 varies by destination. Configurations corresponding to the remote controllers have conventionally needed to be developed for respective destinations. The present embodiment can provide products according to destinations by installing the functional expansion module (the sensor module) adapted to a destination, resulting in a reduction in a development burden.

The television display device 100 according to the present embodiment has a function to operate the function expansion module independently of the common controller 101. This allows the function expansion module to operate independently, thereby allowing control of the function (recording or the like) of the function expansion module even when the power of the common controller 101 is turned off. This can reduce a reduction in power consumption.

Video output devices comprising television display devices vary in necessary sensor specification and the necessary number of sensors, depending on whether the targets of products are high end or low end. Sensors have conventionally needed to be installed according to targets. The present embodiment can provide products corresponding to targets by providing sensor modules corresponding to targets, resulting in a reduction in a development burden.

In the present embodiment, video and audio data is input and output through the interface for home appliances serving as a video interface between the common controller 101 and the function expansion module, thereby allowing the common controller 101 alone to be used as a monitor.

### Second Embodiment

The above embodiment describes a case of providing only one power supply module. However, without being limited to one power supply module, the power supply module may be provided in plurality.

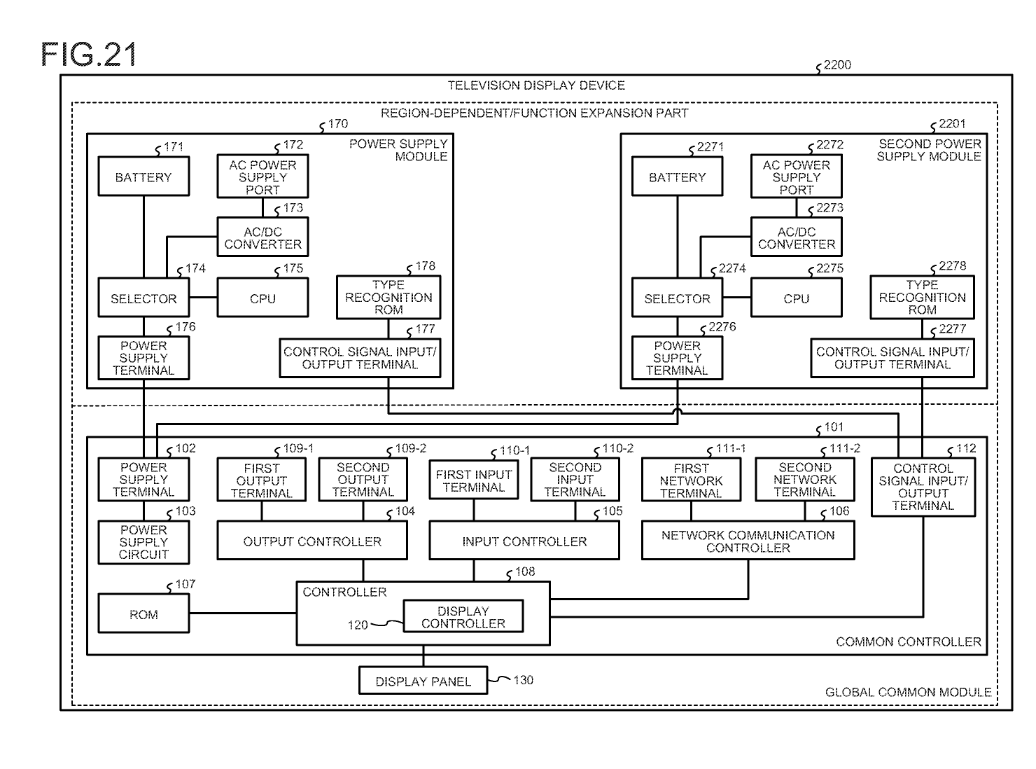

FIG. 21 is a diagram illustrating a configuration in which a television display device 2200 according to a second embodiment comprises a plurality of power supply modules as the function expansion modules. As illustrated in FIG. 21, the television display device 2200 comprises the power supply module 170 and a second power supply module 2201. The configuration of the power supply module 170 is already described above, and the description thereof will be omitted.

The second power supply module 2201 comprises a battery 2271, an AC power supply port 2272, an AC/DC converter 2273, a selector 2274, a CPU 2275, a power supply terminal 2276, a control signal input/output terminal 2277, and a type recognition ROM 2278. The respective components are similar to those of the power supply module 170, and the description thereof will be omitted.

Upon recognizing that a plurality of power supply modules are connected, the television display device 2200 according to the present embodiment instructs anyone of the power supply modules to control power. The present embodiment is an example of instructing the power supply module 170 to control power. This causes the power supply module 170 to control power supply first.

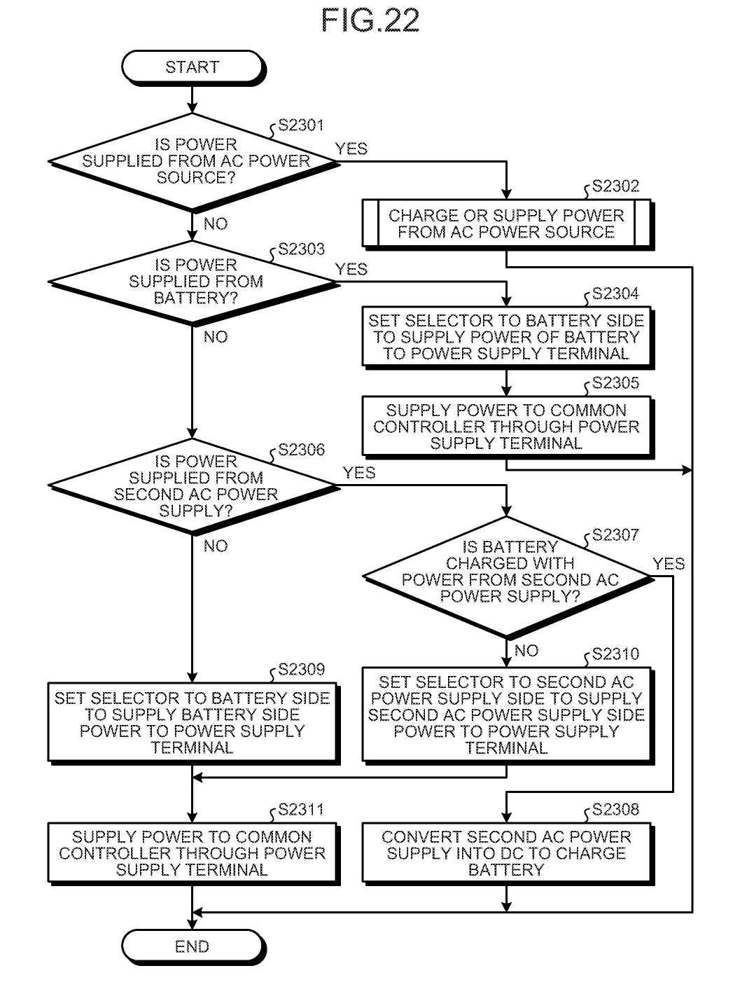

Described next is power supply processing from a power supply in the television display device 2200 according to the present embodiment. FIG. 22 is a flowchart illustrating the procedure of the above processing in the television display device 2200 according to the present embodiment.

First, the CPU 175 of the power supply module 170 determines whether power is to be supplied from the AC power supply connected through the AC power supply port 172 of the power supply module 170 (S2301). If the CPU 175 determines that power is to be supplied (Yes at S2301), it causes the power from the AC power source connected through the AC power supply port 172 to be supplied to charge the battery 171 and to the common controller 101 as in S402 to S406 in FIG. 4 (S2302).

If the CPU 175 of the power supply module 170 determines that power is not to be supplied from the AC power supply through the AC power supply port 172 of the power supply module 170 (No at S2301), the CPU 175 determines whether power is to be supplied from the battery 171 of the power supply module 170 (S2303).

If the CPU 175 determines that power is to be supplied from the battery 171 of the power supply module 170 (Yes at S2303), it sets the selector 174 to the battery 171 side to supply the power of the battery 171 to the power supply terminal 176 (S2304). This causes power to be supplied to the common controller 101 through the power supply terminal 102 (S2305).

If the CPU 175 determines that power is not to be supplied from the battery 171 of the power supply module 170 (No at S2303), the CPU 175 reports to the common controller 101 that the power supply module 170 is not used. Upon receipt of the report, the common controller 101 instructs the CPU 2275 of the second power supply module 2201 to control power supply. This causes the CPU 2275 of the second power supply module 2201 to determine whether power is to be supplied from a second AC power supply connected through the AC power supply port 2272 of the second power supply module 2201 (S2306). If the CPU 2275 determines that power is not to be supplied from the second AC power supply (No at S2306), it sets the selector 2274 of the second power supply module 2201 to the battery 2271 side to supply the power of the battery 2271 to the power supply terminal 2276 (S2309).

If the CPU 2275 determines that power is to be supplied from the second AC power supply (Yes at S2306), it determines whether the battery 2271 of the second power supply module 2201 is to be charged with the power from the second AC power supply (S2307). If the CPU 2275 determines that the battery 2271 is to be charged with the power from the second AC power supply (Yes at S2307), it causes the power supplied from the second AC power supply to be converted into DC to charge the battery 2271 (S2308).

If the CPU 2275 determines that the battery 2271 of the second power supply module 2201 is not to be charged (No at S2307), it sets the selector 2274 to the AC power supply side to supply AC power supply side power to the power supply terminal 2276 (S2310). After the processing at S2309 or S2310, power is supplied to the common controller 101 through the power supply terminal 2276 (S2311).

Through the above processing, power supply is performed in the television display device 2200.

The television display device 2200 according to the present embodiment allows a plurality of power supply modules to be connected and allows the common controller 101 to control which battery is used based on the remaining amounts of the respective batteries installed in the power supply modules.

In the above embodiments, attachment of a function expansion module according to target users or regions provides products according to target users or regions.

In the above embodiments, the HDD of the function expansion unit or the expansion memory stores therein menu screen (GUI) data, screen data at setup, audio data, screen data at help, and font data. In conventional technologies, they need to be stored in a built-in ROM mounted on a (main) control board built in a television display device. In contrast, the above embodiments allow attachment of a function expansion module in which various pieces of screen data corresponding to destinations or functions are stored in the HDD or the like, thereby performing setting on products according to destinations or functions. This reduces a development burden.

The above embodiments facilitate applications of products at different levels and in different fields according to destinations or target users. Development is not required for each product, resulting in a reduction in a development burden. This achieves cost reduction.

In the above embodiments, attachment and detachment of function expansion modules achieves variations in the tuner according to destinations, variations in the remote controller, variations in the AC power source according to destinations, and variations in the function based on variations in usage and about low end/high end. This configuration achieves standardization of components, and hence, achieves cost reduction. For a similar reason, design man-hours are reduced, and design efficiency improves.

In the above embodiments, failure can be addressed by replacing a failed function expansion module, thereby resulting in a reduction the cost of repair.

In the above embodiments, when an abnormal phenomenon occurs in a product, a log and a record of the abnormality can be kept in a function expansion module. The normal common controller 101 and an external device can check the log and the record, resulting in the determination of the cause of the abnormal phenomenon.

In the above embodiments, the addition of a new function (e.g., a new input interface) is achieved simply by development of a new function expansion module, eliminating the need for developing the common controller 101, and thus resulting in an improved design efficiency.

In the above embodiments, a plurality of function expansion modules are developed and manufactured that vary by region or target user of a product. Based on that, a function expansion module among the function expansion modules is installed in the common controller 101 according to users' requests or regions, thereby providing a television display device according to user's requests or regions.

While the broadcasting method varies by destination, the television display device 100 is installed with function expansion modules having the tuner functions of broadcasting methods according to respective destinations in the present embodiment. In view of this, only a function expansion module is developed for each destination, with the common controller used in common regardless of destination, resulting in a reduction in a development burden.

In the above embodiments, video data is input from the common controller 101 to the function expansion module (the input module) and the merge (blend and the generation of a multi-screen simultaneous display image) can be performed on the video data at the function expansion module (the input module). With the control performed by the function expansion module, only a function expansion module needs to be developed to improve the function, and the common controller 101 does not need to be developed, resulting in a reduction in a development burden.

In the above embodiments, the font information, the menu screen information, and the like are held in the function expansion module (e.g., the network communication module). As a result, only the attachment and detachment of the function expansion module are needed to provide font, menu screens, and the like according to regions, and the common controller does not need to be developed, resulting in a reduction in a development burden. This reduces development costs.

The described embodiments have been disclosed as examples and have no intention of limiting the scope of the invention. These novel embodiments can be performed in other various forms, and various omissions, replacements, and alterations can be performed without departing from the spirit of the invention. These embodiments and their modifications are comprised in the scope and the spirit of the invention and are comprised in the invention described in the claims and the scope of their equivalents.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video output device comprising:
a first detachable function expansion module configured to perform input process on video information;
a second detachable function expansion module comprising a storage module configured to store therein at least one of font information and screen information; and
a controller configured to output, to a display, the video information input from the first function expansion module and the at least one of the font information and the screen information input from the second function expansion module.

2. The video output device of claim 1, further comprising:
a third detachable function expansion module configured to merge the video information and other video information, wherein
the controller is configured to provide the video information input from the first function expansion module to the third function expansion module, and to output the video information merged by the third function expansion module to the display.

3. The video output device of claim 1, wherein a function of the first function expansion module and a function of the second function expansion module are configured as one function expansion module.

4. The video output device of claim 1, further comprising:
a fourth function expansion module comprising a sensor configured to receive an infrared signal from a remote controller, wherein
the controller is configured to perform control corresponding to the infrared signal received by the fourth function expansion module.

5. The video output device of claim 1, further comprising:
a fifth detachable function expansion module configured to function as a power supply module configured to supply power to the video output device, wherein
the controller is configured to perform control using power supplied from the fifth function expansion module.

6. The video output device of claim 5, further comprising:
a sixth detachable function expansion module configured to function as a second power supply module configured to supply power to the video output device, wherein
the controller is configured to perform control using power supplied from one of the fifth function expansion module and the sixth function expansion module.

7. A video output method performed in a video output device, the video output device comprising: a first detachable function expansion module configured to perform input process on video information; and a second function expansion module comprising a storage module configured to store therein at least one of font information and screen information, the method comprising:
outputting, to a display, the video information input from the first detachable function expansion module and the at least one of font information and screen information input from the second detachable function expansion module.
